(19) United States
(12) Patent Application Publication
(10) Pub. No.: US 2012/0246326 A1
(43) Pub. Date: Sep. 27, 2012

(54) MECHANISM TO CONVEY DYNAMIC CHARGING INFORMATION OVER SIP

(75) Inventors: Kuldeep Singh, Gurgaon (IN); Durgesh Mishra, Noida (IN); Swaminathan Seetharaman, Chromepet (IN)

(73) Assignee: Alcatel Lucent, Paris (FR)

(21) Appl. No.: 13/384,657

(22) PCT Filed: Jul. 24, 2009
(86) PCT No.: PCT/IN09/00425

§ 371 Date: Jun. 18, 2012

(51) Int. Cl. G06F 15/16

(52) U.S. Cl. 709/227

(57) ABSTRACT

A system and method of providing charging information to the participants for a session is disclosed. User A initiates a session to user B, by sending an invitation message. The message contains an application body. A first method talks about basic charging framework involving network level manipulation and second method being an offer answer model for charging. In network level manipulation, the user A sends an invitation message to proxy server which modifies the application body of the message before sending the message to user B. In offer answer model for charging, user A initiates an offer for charging, which is sent to user B and means of negotiation is involved between both. Means of negotiation allows implementing different charging schemes, and User B or User B's network can also initiate the charging offer.

### BACKGROUND

1. Technical Field

The present invention relates to network communication systems and, more particularly, to charging of sessions in network communication systems.

2. Description of the Related Art

Internet protocol multimedia subsystems (IMS) provide multimedia services over third generation (3G) mobile communication systems. IMS facilitates rich communication between person-to-person and person-to-content over the IP based communication network. IMS uses session initiation protocol (SIP) to set up and control calls or sessions between user terminals. Media components of the session are described by the session description protocol (SDP). Various types of charging systems are known in network management. Charging should be more dynamic in sessions which include several service components. Dynamic charging platforms (DCP) enables real-time, value based charging of advanced network services such as content, mobile commerce and so on. DCP bi-directionally connects and integrates, in real time, the network gateways, probes and servers that generate event information with the authentication, balance management and billing systems. This facilitates instant, two way communications between network elements, pricing engines and customer billing systems along with reliable post event processing to ensure payment and service quality.

Other means for charging the sessions include P-charging vector and P-charging information. The P-charge info is a private SIP header which provides simple billing information and requests the registration of this header. P-charge info is used to convey billing related information for a particular call. The charge related information is typically inserted by the SIP proxy on the originating network. The information can also be inserted by the Public Switched Telephone Network (PSTN) gateways acting as a SIP User Agent (UA). However the P-charge info header does not consider various likely scenarios, as the charging related information is transmitted only in the forward direction. In real-life situations, the charging related information may have to be transported in the backward direction also, and could involve situations where negotiations between both the parties involved in the call is required.

The header field P-charging-vector is used in IMS networks. It is used to carry information related to charging for a particular session. There are differences in semantics between P-charging-vector and P-charging-info. P-charging-vector is used to carry information for the correlation of multiple charging records generated for a single session. Further P-charging-vector also has a means to identify the session for which the charging information is generated. The globally unique identifier is not necessary when carrying information about the user to be billed when it is attached to the corresponding session related signaling. However the process involves complexity and lack of information exchange or negotiation between the parties involved in the session. Inability to implement services like changing the charging aspects between the sessions and so on.

### SUMMARY

In view of the foregoing, an embodiment herein provides a system and method to provide dynamic charging information to the users involved in a communication session. By having a means of negotiations between the participants involved in the session different participants can be charged for different parts of the session.

Embodiments further disclose a method for determining charging information in a SIP/IMS network for an ongoing session. The method comprising of participants involved in the session indicating charging information for media present in the session and the participants of the session negotiating on charging information for the session. The method further comprises of a network of a first user inserting charging information in a message from first user to a second user. The network informing a charged user of charge as indicated in the charging information. Network of second user removes the charging information from the message before forwarding the message to second user. The method further comprises of charging information being inserted in a message from a first user to a second user, the charging information being inserted by one of first user and network of first user. Further the network of first user sending charging information to network of second user and negotiations occurring between the first user, network of first user, second user and network of second user. An acknowledgement being sent to first user on completion of negotiations, and acknowledgement being sent by one of second user, and the network of second user. The method, wherein the charging information is a charging indicator. The charging information can be inserted in one of INVITE message, RE-INVITE message, UPDATE message, 18× response messages, 200 OK messages and ACK messages. The participants comprises of said first user, network of said first user, second user and network of said second user. Wherein the first user and second user are subscribed for one of online charging of sessions and offline charging of sessions. The sessions are charged according to media attributes of said sessions. The user to be charged for sessions may change during the sessions depending on events occurring during the session.

The mechanism, determines charging based information for an on going session in a SIP or IMS network. The mechanism provides charging information for media content of a session to the participants involved in the session. In addition, the mechanism provides a means of negotiation for participants to negotiate charging based information for a session. The system further comprises of an insertion means for network of a first user to insert charging information in a message from the first user to a second user. Information means for the network, to inform, a charged user of charge as indicated in charging information. A removal means for network of second user to remove charging information from the message before forwarding the message to second user. The system further comprises of an insertion means for charging information to be inserted in a message from a first user to a second user, charging information being inserted by one of said first user and network of first user. A sending means for network of the first user to send charging information to network of said second user. A negotiation means for carrying out negotiations between first user, network of the first user, second user and network of second user. An acknowledgement means for sending an acknowledgement to first user on completion of negotiations, the acknowledgement being sent by one of second user and network of second user.

These and other aspects of the embodiments herein will be better appreciated and understood when considered in conjunction with the following description and the accompanying drawings.

### BRIEF DESCRIPTION OF THE DRAWINGS

The embodiments herein will be better understood from the following detailed description with reference to the drawings, in which:

FIG. 1 is a system diagram illustrating the elements of the system, in accordance with the embodiments herein;

FIG. 2 illustrates the system diagram with the network elements, in accordance with the embodiments herein;

FIG. 3 is a sequence diagram illustrating the Basic charging indicator framework for Session Initiation Protocol (SIP) network, in accordance with the embodiments herein;

FIGS. 4a and 4b are sequence diagrams illustrating a Basic charging indicator framework for IMS (Internet Protocol Multimedia Subsystem) network, in accordance with the embodiments herein;

FIG. 5 illustrates a sequence diagram of offer answer model for charging in SIP network, in accordance with the embodiments herein;

FIGS. 6a, 6b, 6c and 6d illustrate a sequence diagram of offer answer model for charging in IMS outwork, where user A has offline charging and user B has online charging mechanism active, in accordance with the embodiments herein; and

FIGS. 7a, 7b, 7c and 7d illustrate a sequence diagram of offer answer model for charging in IMS network, where user A has online charging and user B has offline charging mechanism active, in accordance with the embodiments herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

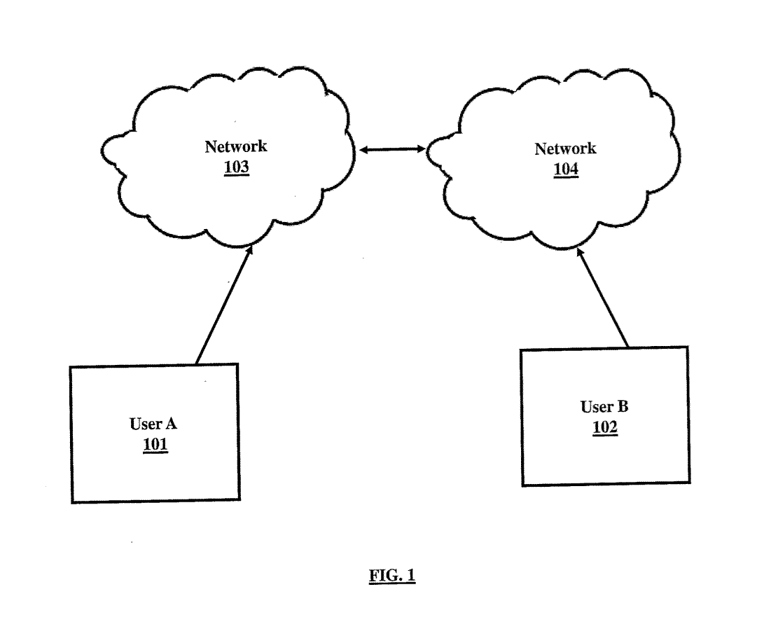

The embodiments herein achieve a method of providing charging related information to user of a session by providing a mechanism in SIP to convey charge related information and a means of negotiation between entities and/or the users involved in the session. Referring now to the drawings, and more particularly to FIGS. 1 through 7, where similar reference characters denote corresponding features consistently throughout the figures, there are shown embodiments.

FIG. 1 is a system diagram illustrating the elements of the system, in accordance with the embodiments herein. The calling party is referred to as User A 101 and the called party is referred to as User B 102 hereafter. User A 101 initiates a session to user B 102 through the network 103. The network 103 may be an Internet Protocol Multimedia Subsystem (IMS) network or a Session Initiation Protocol (SIP) network. IMS network is used for delivering Internet Protocol (IP) multimedia content comprising of a combination of text, audio, still images, animation, video and interactivity contents. Unlike, a traditional switched network, 1MS does not establish media paths when a session is established. The capacity for transporting media is not allocated until a media transport session is actually needed and established. Hence media transport actions such as session transfer or forwarding can be optimized. Establishment of IMS based communication sessions involve negotiation of media capabilities between the users involved in the session. For illustration purposes, consider a non-IMS SIP network. Further, various actions and session flows here are described for a non-IMS SIP network. However, the mechanism can also be implemented for an IMS network. The network (103) comprising of various network elements such as the proxy servers, application server, call session control functions, online charging functions, charging data functions, and home subscriber server. In SIP networks, the Session Initiation Protocol is involved in setting up multimedia communication sessions. The protocol can be used for creating, modifying or terminating sessions comprising of several media streams. The SIP can support session processing functions and features present in the Public Switched Telephone Network (PSTN). SIP network comprises proxy server and user agent. The user A 101 initiates a session to user B 102 by sending an invitation message, where the invitation message could be in the form of INVITE or the like. The invitation message contains an application body and charging related information. The charging related information could be transported in the application body in the form of application/sdp, ci. The charging related information may include type of media content, charging indicator, application and session description protocol details. Details such as the type of the media content delivered and charging information is also present in the application body. Charging indicator indicates what part of the session is charged to different users. The proxy server is responsible for inserting the charging related information in the application body of the message and is inserted only in the new application body. The application server (AS) checks the profile settings of the user to determine if the user has authorization for a particular content. The application server (AS) also examines any information related to charging indicator, during the session set up phase, to take appropriate actions and trigger the appropriate charge indicator information to be passed. In network level manipulation method, user's preferences are stored in the proxy. Details like reverse charging acceptable or not, event based charging facilities etc are stored in the proxy server. The session is initiated by user A 101 by sending an invitation message. The invitation message is sent to the proxy server of the network of user A 101. The proxy server checks for the profile settings of the user A 101 and accordingly inserts the application body contents in the invitation message. The proxy server inserts the charging indicator related information in the application body of the message, whereas the SDP part is already inserted by the calling user in the application body when user A 101 sends the invite message. The invitation message is sent to the proxy server of user B 102. The proxy server removes the charging indicator related information from the application body of the invitation message before the invitation message is sent to the user B 102.

In case of offer answer model for charging, user A 101 initiates a session through the originating network 103 to user B 102. User A 101 sends an invitation message with application body. The application body may include the offer for charging. The invitation message is sent to user B 102 through the network elements. User B 102 may accept the offer and continue the session by sending a response message, whereas, if the offer is not acceptable to user B 102, the offer is rejected and a response is sent by user B 102. Further, user A 102 may send a re-invitation message with a new offer and the session continues. Error or unsuccessful scenarios is handled by AS, for example, considering the case wherein the user A 101 belongs to one network 103 and user B 102 belongs to another network 104. The charging information or offer made by one network 103 may not acceptable to the other network 104 if the originating network 103 inserts the charging indicator as ‘called’ and the terminating network 104 does not facilitate reverse charging. In such case, the offer is not accepted and the session may be terminated by sending a response message or the session may be accepted and an update message is sent with the charging indicator as ‘calling’. If the offer is not acceptable by the originating network 103 the session may be terminated.

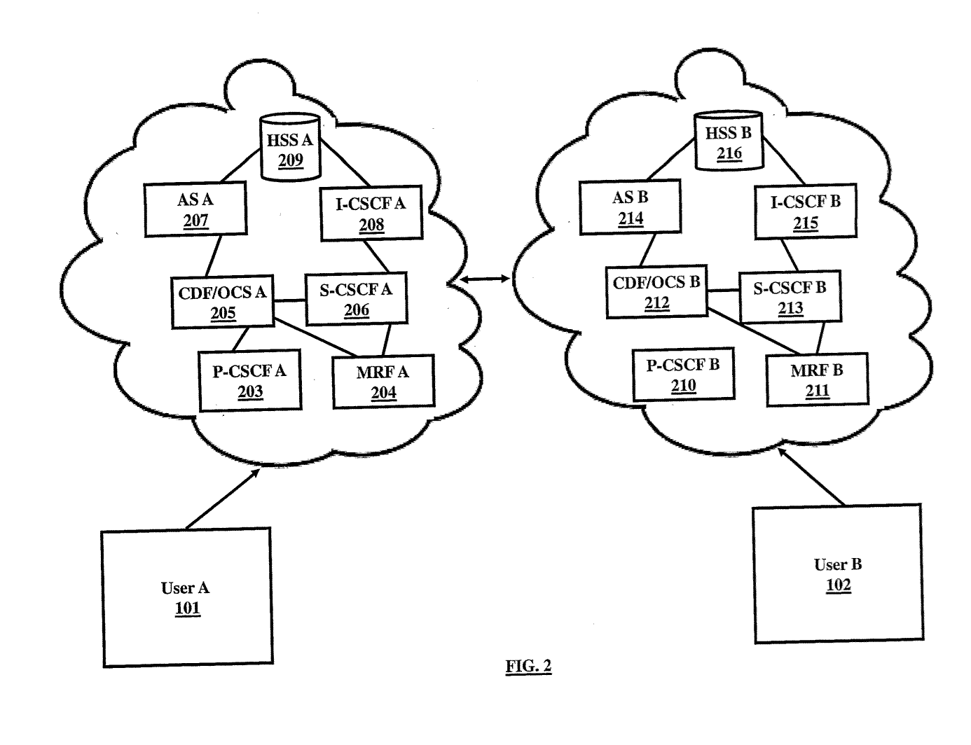

FIG. 2 illustrates the system diagram with the network elements, in accordance with the embodiments herein. User A 101 initiates a session to user B 102 through the network 103. The network 103 may be an Internet Protocol Multimedia Subsystem (IMS) network or a Session Initiation Protocol (SIP) network. For example, consider the case of an IMS network. IMS network is used for delivering Internet Protocol (IP) multimedia content comprising of a combination of text, audio, still images, animation, video and interactivity contents. The network 103 comprises of Home Subscriber network (HSS) 209/216, Application server (AS) 207/214, Interrogating call Session Control Function (I-CSCF) 208/215, Serving Call Session Control Function (S-CSCF) 206/213, Proxy Call Session Control Function (P-CSCF) 203/210, Charging Data Function (CDF)/Online Charging System (OCS) 205/212, Media Resource Function (MRF) 204/211. The HSS 209/216 is a master repository that supports the IMS entities actually handling the calls. HSS 209/216 contains subscription related information from the user profile, performs authentication, authorization of the user and includes information about the identity of the user, roaming profile etc. The default settings could be present in the user's profile for a particular charging indicator for sessions to certain users or sessions involving certain media types. The default settings information is passed to the AS 207/214 by the HSS 209/216 as part of the user profile information. Also, reverse charging can be defined in the HSS 209/216 and may be applicable for all incoming sessions or may be selective depending on certain pre-defined. criteria. The AS 207/214 hosts and executes the service and interfaces the S-CSCF 206/213 using the SIP. Depending on the actual mode of service the S-CSCF 206/213 can operate in SIP proxy mode or SIP user agent mode. AS 207/214 can reside in the home network or an external network. Charging related information available in the user profile is examined by the AS 207/214. During the session set up phase, the AS 207/214 takes appropriate actions and triggers appropriate charge related information to be passed in the protocol messages. AS 207/214 interacts with the charging functions on receiving information from the charging indicator. AS 207/214 plays the role of Originating Charging Determinant (OCD) or Terminating Charging Determinant (TCD) depending on whether the AS 207/214 is at the originating side or the terminating side. The origination charging determinant (OCD) is the first proxy from the caller to the called that manipulates the charging related information in the application body of the invitation message. In case of IMS networks, the OCD is typically the AS of the calling user. The OCD may also be the S-CSCF of the calling user. The terminating charging determinant (TCD) is the last proxy from the caller to the called that manipulates the charging related information in the application body of the invitation message. In case of IMS networks, the TCD would be the AS or S-CSCF of the called user in some cases. Error or unsuccessful negotiation cases are handled by the AS 207/214. Several roles of SIP servers or proxies collectively called as Call Session Control functions (CSCF) are used to process SIP packets in the IMS. P-CSCF 203/210 is SIP proxy and is the first point of contact for the IMS terminal. The P-CSCF 203/210 is in the path of all signaling messages and inspects every single message. P-CSCF 203/210 authenticates the user and establishes security association with the IMS terminal. In the basic charging framework, P-CSCF 203/210 is responsible for removing the application body containing the charging related information from the message before sending it to the user. P-CSCF 203/210 also stores the received charging related information, and informs the charging functions accordingly. S-CSCF 206/213 is the central node of signaling plane. S-CSCF 206/213 is a SIP server that performs session control functions too. S-CSCF 206/213 uses DIAMETER protocol interfaces to the HSS 209/216 to download and upload the user profiles. Also, the S-CSCF 206/213 assigns the application server 207/214, to which the SIP message sent by the calling user will be forwarded. The S-CSCF will trigger the AS 207/214 during the session set up phase. When AS 207/214 does not perform the functions as described here, as the AS 207/214 may not be involved in the session flow, the S-CSCF takes up the responsibility of carrying out the functions of AS 207/214. I-CSCF 208/215 is located in the administrative domain. I-CSCF 208/215 queries the HSS 209/216 to retrieve user information and routes the SIP request to the assigned S-CSCF 206/213. Media Resource Function (MRF) 204/211 provides media related functions such as media manipulation and playing of announcements and tones. The Online charging System (OCS) 205/212 provides a mechanism for charging the user for the sessions. OCS 205/212 is similar to a prepaid charging mechanism wherein the user has to hold some credits initially. The OCS 205/212 comprises of Session Control Function (SCF) and Event Charging Function (ECF). The charges for the session are deducted from the user's account. The Charging Data Function (CDF) 205/212 keeps a track of the data related to charging. In OCS 205/212, the S-CSCF 206/213 interacts with the Session Control Function (SCF) that is similar to SIP application server. SCF signals the S-CSCF 206/213 to terminate the session when the user runs out of credits in his account during a session. In Event Charging with Unit Reservation (ECUR) the Event Charging Function (ECF) reserves the number of credit units in the user's account and then authorizes the MRF 204/211 or the AS 207/214 for charging. After the service is over the number of credit units is reported and deducted from the user's account. The reserved credit units are then cleared.

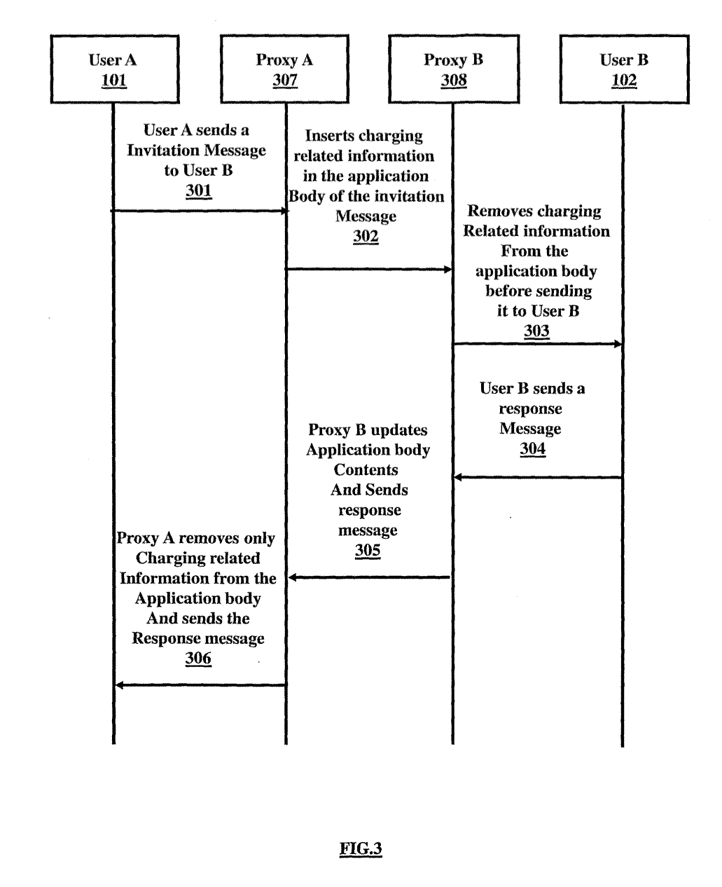

FIG. 3 is a sequence diagram illustrating the Basic charging indicator framework for Session Initiation Protocol (SIP) network, in accordance with the embodiments herein. The user A 101 initiates a session to user B 102. The invitation may be sent in the form of an invitation message, where the invitation message could be in the form of INVITE or the like. The invitation message contains an offer for reverse charging. Reverse charging is defined as a scheme wherein, the called user B 102 will bear the charges for the call. The user A 101 does not insert any charging related information in the SIP message originating from the user A 101. Also, on receiving any message with the charging related information like the application body in the message, the application body will be simply ignored. The invitation message is sent (301) to the proxy server A 307. The proxy server A 307 makes a check of the user A 101 profile settings. The proxy server is mainly responsible for inserting the application body contents in the invitation message. Proxy server inserts only the charging related information in the application body of the invite message, whereas the SDP contents of the application body is inserted by the user terminals. In a preferred embodiment, the application body may comprise of charging related information such as ‘charging indicator’ body. Charging indicator body includes details like the session description protocol (SDP) media content and the corresponding charging details of the party to be charged for a particular content. SDP media content indicates the type of the media delivered and charging indicator indicates the party to be charged for a particular media. The proxy A 307 when inserting the application body contents in the message has to follow a set of pre-defined rules. The rules for the charging indicator update are as shown in the table 1 and table 2 below.

TABLE 1
Charging Indicator update rules (by TCD)

| | TCD | | | |
|---|---|---|---|---|
| OCD | None | Caller | Called | Both |
| None | Allowed | Not Allowed | Allowed | Not Allowed |
| Caller | Not Allowed | Allowed | Not Allowed | Allowed |
| Called | Allowed | Not Allowed | Allowed | Not Allowed |
| Both | Not Allowed | Allowed | Not Allowed | Allowed |

TABLE 2
Charging Indicator update rules (by OCD)

| | TCD | | | |
|---|---|---|---|---|
| OCD | None | Caller | Called | Both |
| None | Allowed | Allowed | Not Allowed | Allowed |
| Caller | Allowed | Allowed | Not Allowed | Not Allowed |
| Called | Not Allowed | Not Allowed | Allowed | Allowed |
| Both | Not Allowed | Not Allowed | Allowed | Allowed |

The originating charging determinant (OCD) is the first proxy from the session initiation side or the caller to the called that manipulates the charge indicator info in the application body. In case of IMS networks, the OCD can be the AS or the S-CSCF, in case the AS is not involved in the session flow. Terminating charge determinant (TCD) is the last proxy from the caller to the called side and manipulates the charging indicator information in the application body. In case of IMS networks, the TCD can be the AS or the S-CSCF in cases where the AS is not involved in the session flow. OCD and TCD decide the user to be charged for the particular media stream. There exist four modes of charging ‘none’, ‘both’, ‘caller’ and ‘called’. OCD can decide any mode of charging but enforce only ‘caller’ whereas TCD can decide any mode of charging but enforce only ‘called’. As an example, if OCD decides ‘none’ for a particular media stream TCD can decide ‘called’ for the same media stream. The highest mode of charging is ‘both’, lowest being ‘none’, and ‘caller’ and ‘called’ lies in between, both at the same level. The charging indicator body is typically inserted in the invitation message in the forward direction by OCD in the invitation message. Proxy A 307 sends (302) the invitation message to proxy B 308. Proxy B 308 checks the profile settings of user B 102 to know if the offer in the application body is acceptable to user B 102. Based on the information received from the charging indicators the proxy B 308 informs the charging entities. Proxy B 308 removes the application body from the invitation message before the invitation message is sent to the user B 102. Proxy B 308 sends (303) the invitation message to user B 102. On receiving the invitation message, user B 102 sends (304) a response message. In an embodiment the response message may be 200 OK response, 18× response and the like. Proxy B 308 updates the earlier application body of the message based on the profile of user B 102 or service logic. Proxy B 308 sends (305) response message to the proxy A 307. Further, the proxy A 307 removes the application body from the response message before sending the response message to the user A 101. Proxy B 307 sends the response message to user A 101. In another embodiment event based charging is also possible. The user to be charged could undergo changes/updates based on some ‘events’ occurring during the session. Examples of such events could be invocation of features such as explicit call transfer, wherein the user wants to transfer the session from one device to the other. If the user is busy or in an area where there is no network coverage, the user may forward the session to a pre-stored number in his profile setting. The user may also decide to modify the session parameters. For example if the user A 101 is running out of the credit in his account he may want to transfer the rest of session charges to user B 102. In such scenarios an update or a re-invitation message is sent containing the updated charging related information.

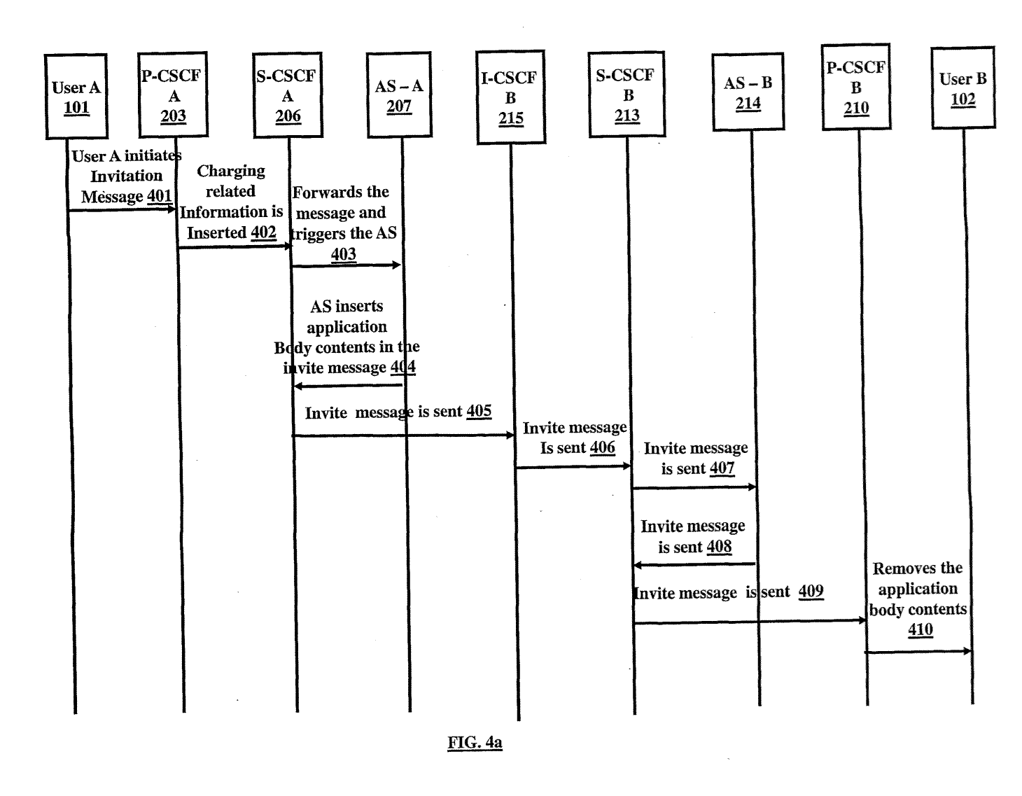

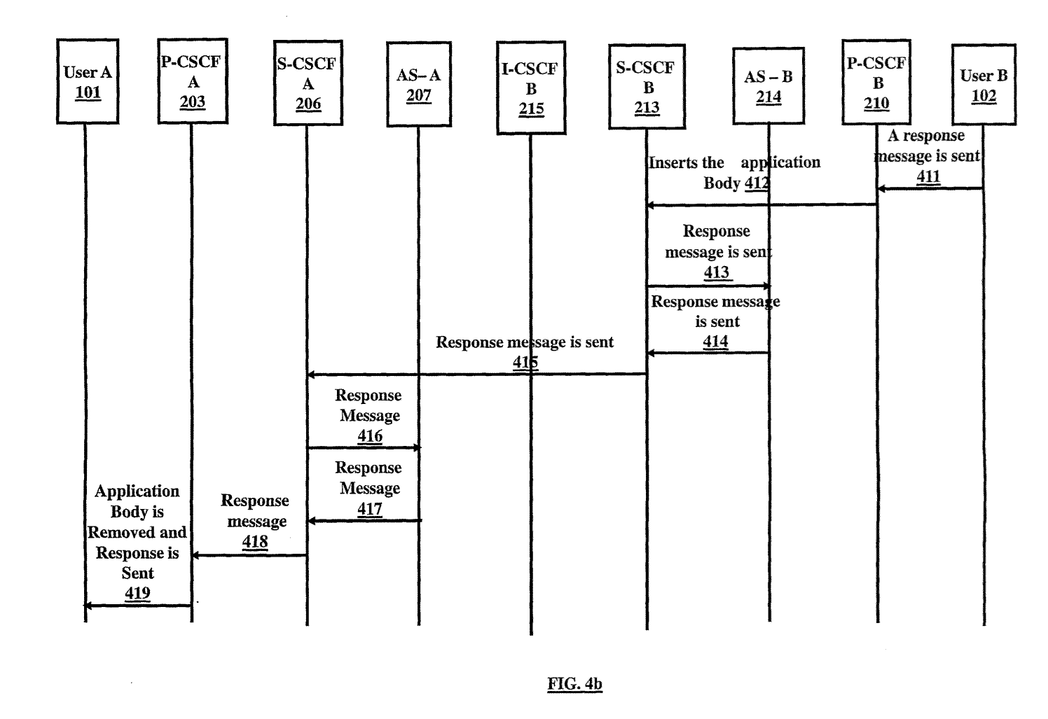

FIGS. 4a and 4b are sequence diagrams illustrating a basic charging indicator framework for IMS (Internet Protocol Multimedia Subsystem) network, in accordance with the embodiments herein. The user A 101 initiates (401) a session to user B 102. The invitation may be sent in the form of an invitation message that may include INVITE and the like. The invitation message contains an offer for reverse charging. Reverse charging indicates the called party or the user B 102 will bear the charges for the session. The user A 101 does not insert any charging related information in the SIP invitation message originating from the user A 101. Also, on receiving any message with the application body contents in the message like charging related information, the application body will be simply ignored. The invitation message is sent to P-CSCF A 203. P-CSCF A 203 is a SIP proxy and is generally the first point of contact for the IMS terminal. P-CSCF A 203 inserts (402) the application body in the invitation message. The invitation message is sent to S-CSCF A 206. S-CSCF A 206 is the central node of signaling plane and performs session control functions too. S-CSCF A 206 uses DIAMETER interface to the HSS A 209 to download and upload the user profiles S-CSCF A 206 assigns the application server A 207 to which the SIP message will be forwarded. S-CSCF A 206 triggers (403) the AS-A 207 to carry out the tasks during the call set up phase. The AS-A 207 inserts the application body in the invitation message and sends (404) the message to S-CSCF A 206. Further S-CSCF A 206 sends (405) the invitation message to I-CSCF B 215. I-CSCF B 215 queries the HSS B 216 to retrieve user information and routes the SIP request to the assigned S-CSCF B 213. The I-CSCF B 215 sends (406) the invitation message to S-CSCF B 213. S-CSCF B 213 examines the invitation message, triggers (407) the AS-B 214 and also indicates the AS-B 214 to which the invitation message is forwarded. Further AS-B 214 checks the user profile and sends (408) the message to S-CSCF B 213. Invitation message is sent (409) to P-CSCF B 210. P-CSCF B 210 removes (410) the application body from the invitation message before sending the invitation message to user B 102. User B 102 generates (411) a response message. The response message may be 200 OK, 18× or the like. P-CSCF A 210 inserts the application body in the response message and the response message is sent (412) to S-CSCF B 213. S-CSCF B 213 sends (413) the response message to AS-B 214 for triggering the AS-B 214 and checking the user profile. The AS-B could update the charging indicator field in the response message, based on the received charging indicator info, and the user profile, etc. Since all the session control functions are performed by the S-CSCF the AS-B 214 sends (414) the response message to the S-CSCF B 213. S-CSCF B 213 sends (415) the response message to S-CSCF A 206. S-CSCF A 206 further sends (416) the response message to AS-A 207 to trigger the functioning of AS-A 207 and inform the charging data functions. AS-A 207 does the necessary actions and sends (417) the message to S-CSCF-A 206. The necessary changes performed by the AS-A 207 comprises of informing of charging functions and so on. The response message is then sent (418) to P-CSCF A 203 which removes any application body from the message. The response message is then sent (419) to the user A 101. In cases where the AS is not involved in interpreting the application body contained in the invite/response message and taking appropriate actions, particularly in the case of online charging, then IMS-GWF will take up the role of AS. Further, IMS-gateway function will interpret the charging related information and take appropriate actions and also interact with the online charging system (OCS). The IMS-GWF will perform functions such as sending the CCR messages during the session set up phase and also requests for unit reservation.

Consider that both the calling party and the called party have offline charging mechanism active. Offline charging is generally defined as a charging mechanism where charging information does not affect in real-time the service rendered, and therefore there is no direct interaction of the charging mechanism with session/service control. The charging data function (CDF) 205/212 is interfaced with the session control functions, AS, MRF. The AS, as a part of accounting request (ACR) message, informs the CDF if different users involved in the session have to be charged for different media types. The information is passed by introducing new attribute value pairs (AVP) Type say media based charging AVP, in the IMS information AVP in the ACR. Some of the usage scenarios would be the called user is charged for video part of the session and the caller is charged for the audio part. Or the session is provided free for the first part, and then charged to the calling party for subsequent part of the session.

Consider both the calling party and the called party have online charging active. Online charging is generally defined as a charging mechanism where charging information can affect, in real-time, the service rendered, and therefore a direct interaction of the charging mechanism with session/service control is needed. In the case for session charging with unit reservation (SCUR), the messages sent to the online charging system such as the credit control request (CCR) will contain media related information as a part of service information attribute value pair (AVP) in the CCR message. The AVP in turn contains the IMS information AVP using which the information would be conveyed to the OCS. In cases wherein the AS is not taking up the functionality of interpreting the application in the SIP message and interacting with the OCS, then the IMS-GWF will take up the role of AS. If the called party is to be charged for the entire session, then the IMS-GWF will send the CCR (initial) message during the session set up, requesting for unit reservation. However, if the called party is to be charged only mid way during the session, a re-invitation message will be triggered, and the CCR (initial) will be sent by the IMS-GWF of the called party towards the OCS on receipt of this re-invitation message, in order to request for credit units reservation from the OCS. Also, combination of online and offline charging mechanisms is possible. At the billing side the Charging data record (CDR) will store the necessary information in order to ensure the users involved in the session are correctly charged.

In another embodiment, consider the scenarios wherein the charging related information provided by one network is not acceptable by the other network. For example, if the originating network inserts the party to be charged as ‘called’ in the application body of the message, whereas the terminating network wants the charged party to be ‘caller’ the case is handled in either of the two ways. The terminating network can reject the session by sending a response message saying charging indicator not acceptable. Or the terminating network accepts the session, continues with the session and subsequently sends an update message with the new application body. If the offer is not acceptable by the originating network, the network will trigger the release of the session.

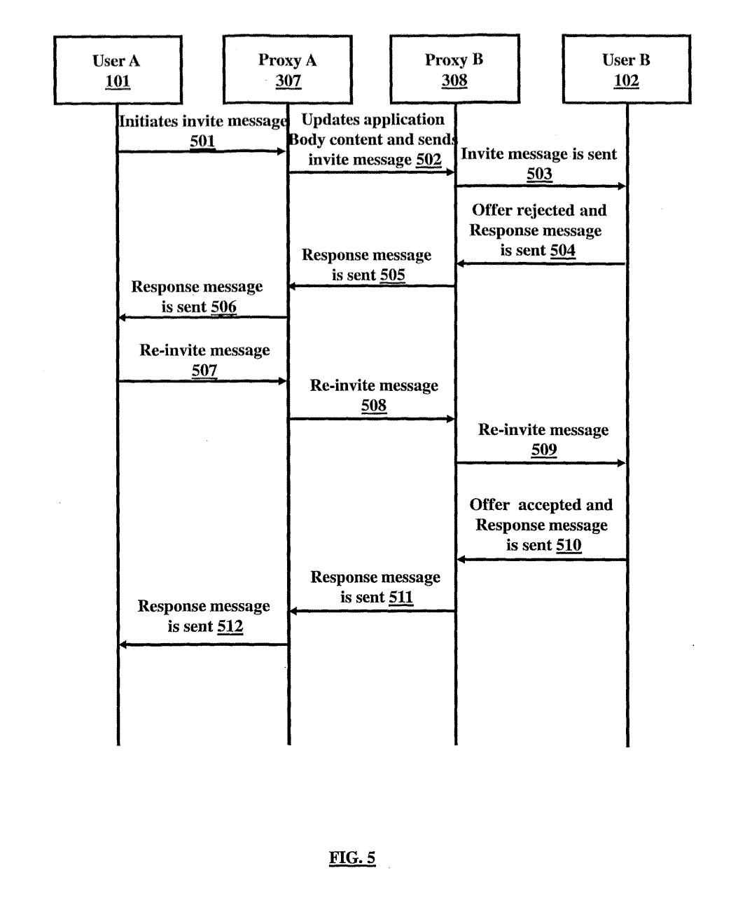

FIG. 5 illustrates a sequence diagram of offer answer model for charging in SIP network, in accordance with the embodiments herein. The user A 101 initiates a session to user B 102. The invitation message may contain offer for reverse charging. In the offer answer model for charging, the various network elements such as User agent (UA), Application server (AS)/S-CSCF can initiate a charging offer. The MGCF can also initiate a charging offer in case of interworking with PSTN/PLMN. Further the offer may be sent in any of the following request messages such as INVITE, UPDATE, INFO etc. Reverse charging indicates the called party or the user B 102 will bear the charges for the session. User A 101 and user B 102 can have either online charging or offline charging mechanism. The invitation message is sent (501) to proxy A 307. Proxy A 307 checks the profile of the user A 101 and updates (502) the application body of the message. Proxy A 307 also interacts with the charging functions. Proxy A 307 sends the invitation message to proxy B 308. User B 102 receives (503) the invitation message from Proxy B 308. The offer may be not acceptable to user B 102, user B 102 rejects (504) the charging offer and sends an appropriate answer in the response message to proxy B 308. The response message can be in the form of 200 OK, 18× or the ACK response. Proxy B 102 interacts with the charging functions accordingly. The response message is sent (505) to proxy A 307. Proxy A 308 interacts with the charging functions to inform the charging functions of the information about charging. Response message is sent (506) to user A 102. User A 102 generates a re-invitation message with a new offer for charging. The re-invitation message is sent (507) to proxy A 308. Proxy A 307 sends (508) the re-invitation message to proxy B 308 with updates in the application body of the message. Proxy B sends (509) the re-invitation message to user B 102. User B 102 accepts the offer for charging and sends (510) a response message to proxy B 308. Proxy B 308 interacts with the charging functions and sends (511) the response message to proxy A 307. Further proxy A 307 sends (512) the response message to user A 101. As an embodiment a new offer cannot be initiated when there is an outstanding offer yet to be answered. In addition a new offer can also be inserted in the answer or the response message.

In another embodiment event based charging mechanism is possible. In case the user to be charged could undergo updates or changes based on ‘events’ occurring during the session. Some examples of such events could be an explicit session transfer where the user would want to transfer the session in the middle from his device to another device. Or forwarding the session to a pre-stored number when the user is busy or is out of coverage area of the network. In the above scenarios the terminating side (TCD) can update the charging indicator and send a new offer for the charging information in the appropriate message.

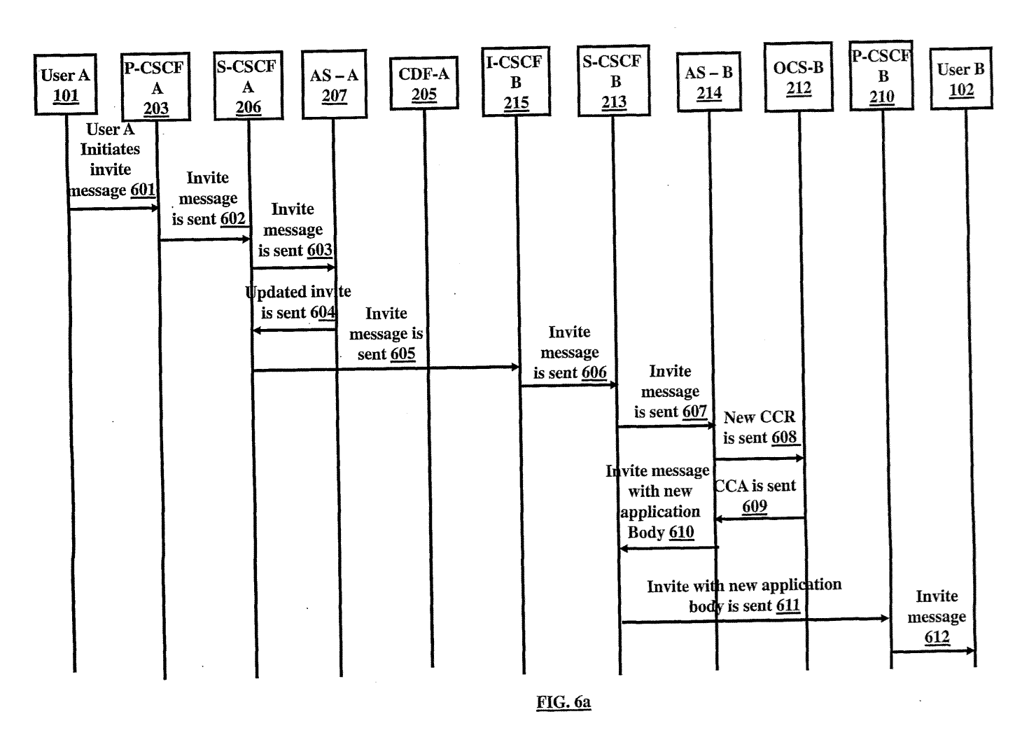

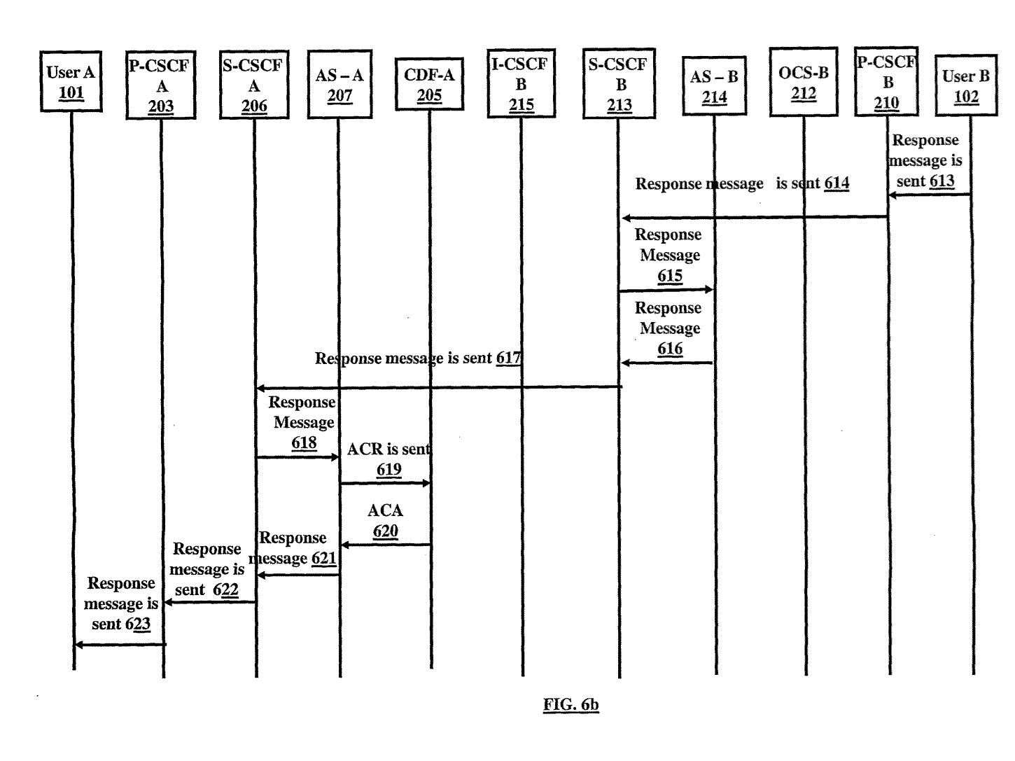

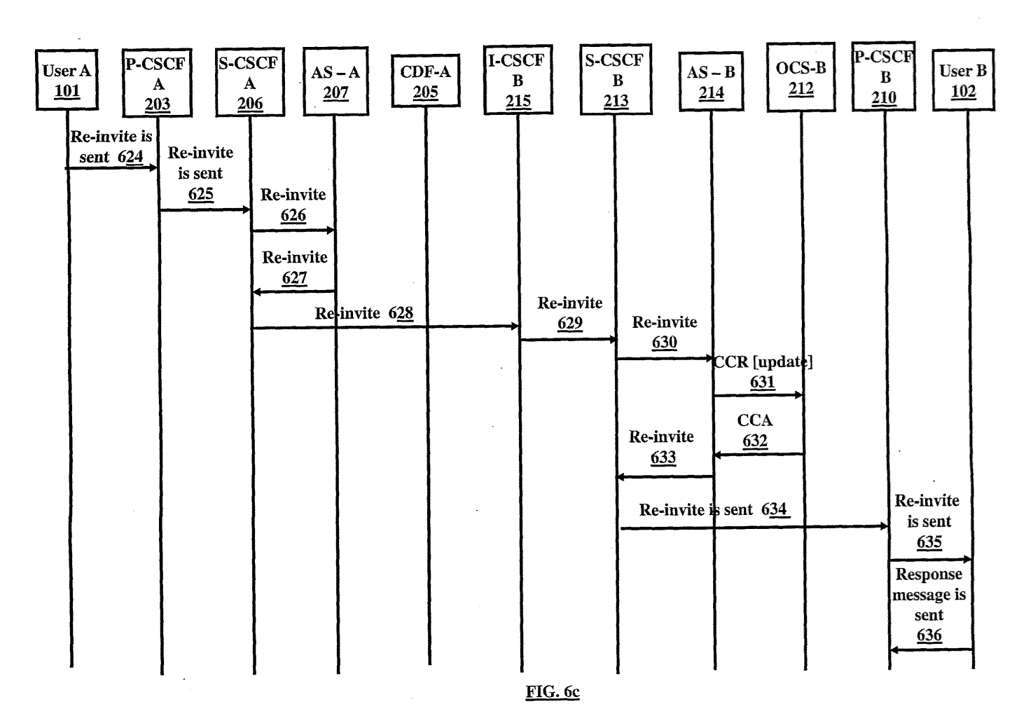

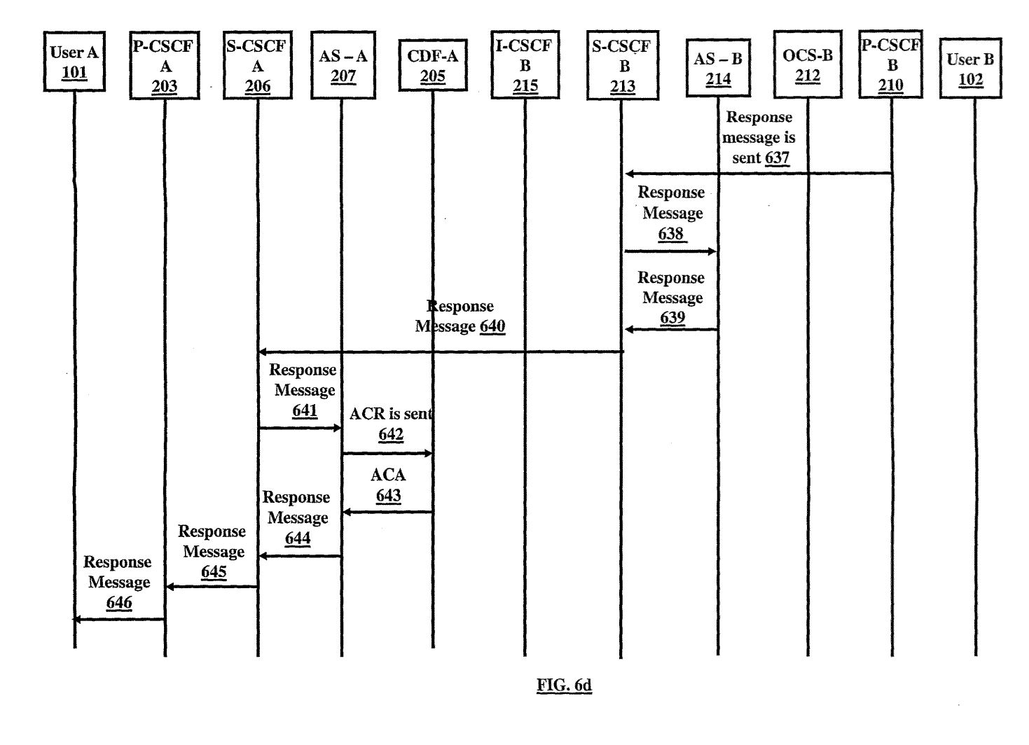

FIGS. 6a, 6b, 6c and 6d illustrate a sequence diagram of offer answer model for charging in IMS network, where user A has offline charging and user B has online charging mechanism active, in accordance with the embodiments herein. User A 101 initiates a session to user B 102. The invitation is sent in the form of an invitation message such as INVITE or the like. Further the offer for charging may be sent in any of the following request messages INVITE, UPDATE, INFO and the like. The invitation message includes offer for reverse charging. Reverse charging indicates the called party or the user B 102 will bear the charges for the session. In the present scenario User A 101 has offline charging and user B 102 has online charging mechanism. User A 101 makes an offer for the charging of the session and sends (601) the offer in the invitation message. Unlike the case of network level manipulation in offer answer model, user A 101 can also insert the offer for charging. P-CSCF A 203 examines the invitation message. The invitation message with the same body contents is sent (602) to the S-CSCF A 206. The S-CSCF A 206 will trigger the AS-A 207 during the call set up phase. The invitation message is sent (603) to the AS-A 207. The AS-A 207 hosts and executes the service and interfaces the S-CSCF A 206 using the SIP. Charging related information available in the user profile is examined by the AS-A 207. During the session set up phase, AS-A 207 takes appropriate actions and triggers appropriate charge related information to be passed. AS-A 207 also interacts with the charging functions on receiving information in the charging indicator. AS-A 207 will check if the user has authorization to include details in the invitation message such as the charging indicator media content. In addition, the application body contents such as charging information etc are inserted in the invitation message by the AS-A 207. The AS-A 207 then sends (604) the invitation message to S-CSCF A 206 since the session handling functions are performed by the S-CSCF A 206. The S-CSCF A 206 sends (605) the invitation message to I-CSCF B 215 that queries the HSS B 216 to retrieve user information and routes the SIP request to the assigned S-CSCF B 213. The I-CSCF B 215 sends (606) the invitation message to S-CSCF B 213. Further invitation message is sent (607) by the S-CSCF B 215 to AS-B 214. The AS-B 214 checks the profile of user B 102 and the service logic, based on these checks the AS-B 214 determines the desired settings of the user B 102. These settings are compared with the offer made by the user A 101. The contents of the application body like the charging indications are updated accordingly. Further, the AS-B 214 sends the credit charging request (CCR) [initial] message to the online charging system (OCS) as the user B 102 has to be charged. The CCR message contains media based charging information attribute value pairs (AVP) in the MS AVP. In another embodiment if the above functions are not performed by the AS-B 214 then S-CSCF B 213 would send the invitation message to IMS-GWF. Further, the IMS-GWF will carry out the task of sending the CCR message and so on. The CCR message is sent (608) to OCS-B 212. In response to the CCR message the OCS-B 212 will send (609) a CCA message back to the AS-B 214. The invitation message with the new application body is sent (610) to the S-CSCF B 213. S-CSCF B 213 sends (611) the invitation message to the P-CSCF B 210. P-CSCF 13 210 sends (612) the invitation message to the user B 102. User B 102 refuses the offer and updates the application body contents of the message. The user B 102 sends (613) a response message to P-CSCF B 210. P-CSCF B 210 sends (614) the response message to S-CSCF B 213. The response message is then sent (615) to AS-B 214 by the S-CSCF B 213. Response message is then sent (616) back to S-CSCF B 213. S-CSCF B 213 sends (617) the response message to S-CSCF A 206 for the further continuation of the session. The response message is sent by S-CSCF A 206 (618) to AS-A 207. AS-A 207 (after checking the profile settings of User B if applicable) sends (619) the ACR [Start] message to CDF-A 205. In the case of AS-A 207 not being involved in the session, the ACR with the new media based charging information AVP will be sent by the S-CSCF A 206. In response, the CDF-A 205 sends (620) the ACA message. AS-A 207 sends (621) the response message to S-CSCF A 206. S-CSCF A 206 sends (622) the response message to P-CSCF A 203. The response message is then sent (623) to the user A 101. The session continues after User A 101 sends an acknowledgment to the response message (e.g., ACK). User A 101 generates a re-invitation message with the new offer for charging. The re-invitation message is sent (624) to P-CSCF 203. The re-invitation message is sent (625) to S-CSCF A 206. The re-invitation message is sent (626) to AS-A 207. AS-A 207 on checking for the application body updates and sends (627) the re-invitation message back to S-CSCF A 206. S-CSCF A 206 sends (628) the re-invitation message to I-CSCF B 215. Re-invitation message is then sent (629) to S-CSCF B 213, that sends (630) the message to AS-B 214. The AS-B 214 sends a CCR message to the OCS-13 212, as there is update in the media to be charged. Thus, the CCR [Update] is sent (631) to the OCS-B 212. On receiving the message the OCS-B 212 sends (632) a CCA in the form of an acknowledgment to S-CSCF-B 213. Further, the Re-invite is sent (633) to S-CSCF B 213 that then sends (634) the re-invitation message to P-CSCF B 210. The re-invitation is sent (635) to user B 102. User B 102 accepts the new offer, and sends (636) a response message with the new application body (containing the charging indicator information). The response message can be in the form of either 200 OK or 18× and the like. The response message is then sent to P-CSCF B 210, which sends (637) the message to S-CSCF B 213. The response message is sent (638) by S-CSCF B 213 to AS-B 214. AS-B 214 checks the response message and sends (639) the response message to S-CSCF B 213. S-CSCF B 213 sends (640) the response message to S-CSCF A 206. S-CSCF A 206 sends (641) the response message to AS-A 207. On receiving the response message, the AS-A 207 generates an ACR message and the message is sent (642) to CDF-A 205. As a response to the ACR an ACA message is sent (643) back in the form of acknowledgment to AS-A 207. On receipt of the ACA, the response message is sent (644) to S-CSCF A 206 which does the session control functions. The response message is then sent (645) to P-CSCF A 203 and P-CSCF A 203 sends (646) the response message to User B 102.

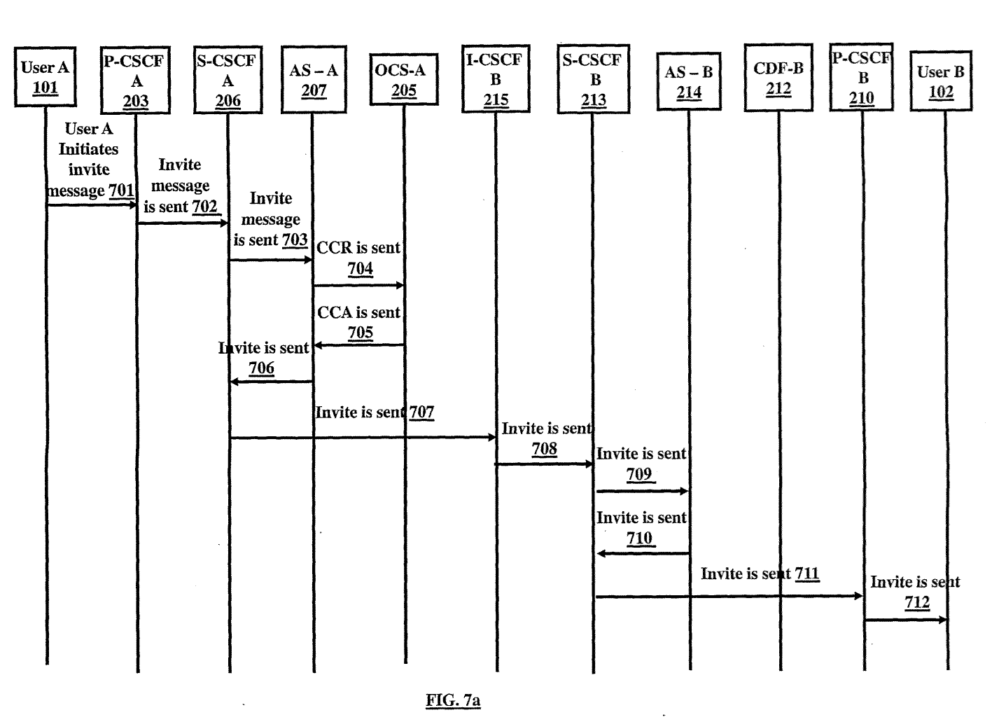

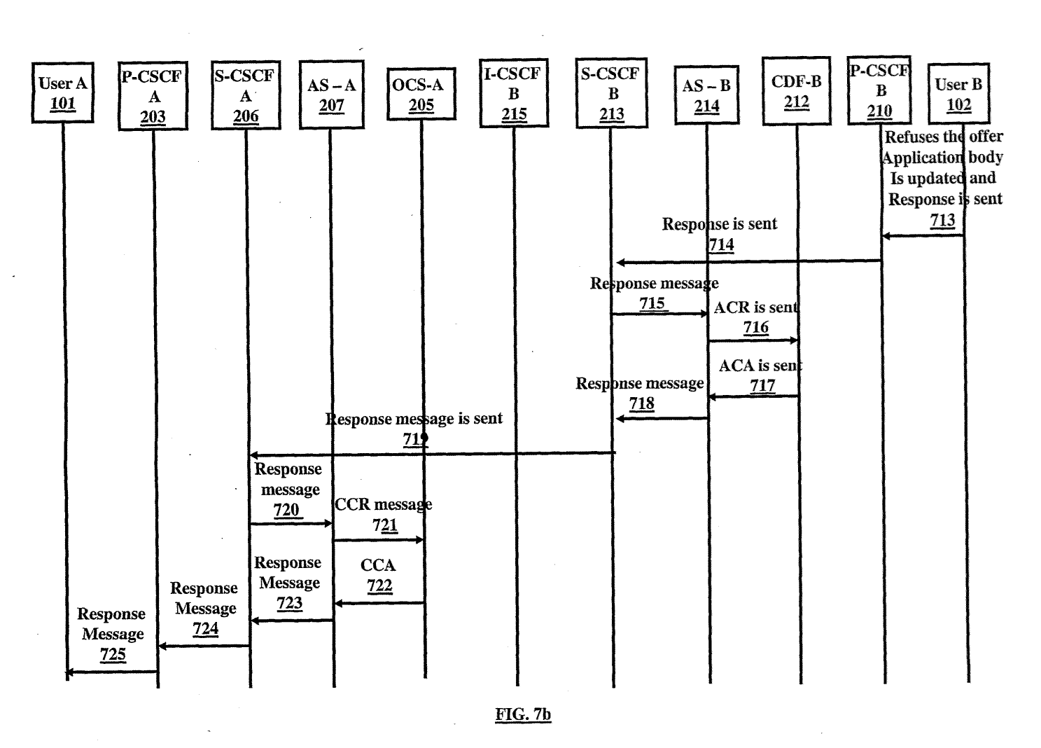

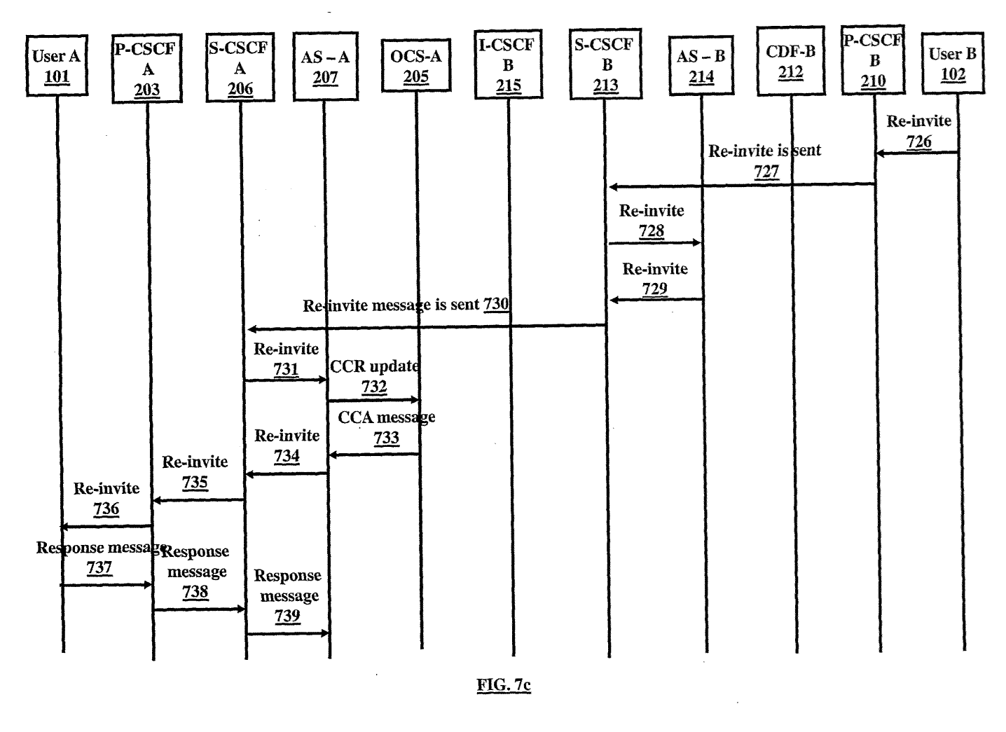

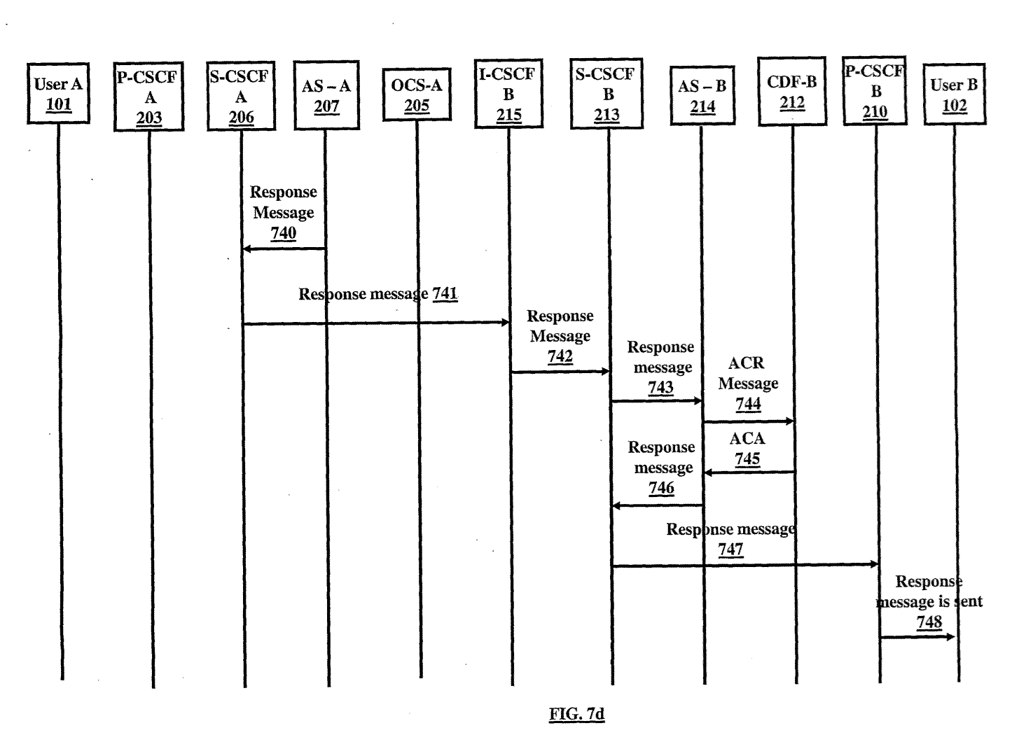

FIGS. 7a, 7b, 7c and 7d illustrate a sequence diagram of offer answer model for charging in 1MS network, where user A has online charging and user B has offline charging mechanism active, in accordance with the embodiments herein. User A 101 initiates a session to user B 102. The invitation is sent in the form of an invitation message such as INVITE or the like. Further the offer for charging may be sent in any of the following request messages INVITE, UPDATE, INFO. The invitation message includes offer for reverse charging. In the present scenario User A 101 has online charging and user B 102 has offline charging mechanism. User A 101 makes an offer for the charging of the session and sends (701) it in the invitation message. Unlike the case of network level manipulation, in offer answer model the end user can also insert the offer for charging. P-CSCF A 203 examines the invitation message. The invitation message with the same body contents is sent (702) to the S-CSCF A 206. The S-CSCF A 206 will trigger the AS-A 207 during the session set up phase. The invitation message is sent (703) to the AS-A 207. The AS-A 207 will examine the user profile and checks if the user A 101 has privilege to include the information related to charging in the invitation message. The charging related information can include media content and charging indications for the charging. The AS-A 207 need not necessarily send the CCR,[initial] since the charging offer does not require the calling party to be charged in the present scenario. In case the AS-A 207 is not involved in the session, then the S-CSCF will send the invitation message to the IMS-GWF, and IMS-GWF will send the CCR message to the OCS. In the present case since AS-A 207 carries out the call flow functions, AS-A 207 sends (704) the CCR message to OCS-A 205. In response the OCS sends (705) CCA message back to AS-A 207 in the form of any acknowledgment for CCR message. The AS-A 207 then sends (706) the invitation message to S-CSCF A 206. S-CSCF A 206 handles all the controlling operation of the session. S-CSCF A 206 sends (707) the invitation message to I-CSCF B 215. I-CSCF B 215 queries the HSS 13 216 to retrieve user information and routes the SIP request to the assigned S-CSCF 213. I-CSCF B 215 sends (708) the invitation message to S-CSCF B 213. S-CSCF B 213 examines the message and sends (709) the invitation message with the same application body to AS-B 214. AS-B 214 checks the profile setting of user B 102 and updates the application body details such as media content and charging related information. On updating, the AS-B 214 sends (710) the invitation message to S-CSCF B 213. S-CSCF B 213 sends (711) the invitation message to P-CSCF B 210. P-CSCF B 210 sends (712) the invitation message to the user B 102. Since the message contains an offer with the charges for video part, that is not acceptable to the user 13 102, user B 102 refuses the charges and updates the application body contents of the invitation message. As another alternative the user B 102 can also reject the request for the session. User B 102 generates a response message on accepting the invitation message. The response message is sent (713) to the P-CSCF B 210. P-CSCF B 210 sends (714) the response message with the same application body to S-CSCF B 213. S-CSCF B 213 sends (715) the response message to AS-B 214. The AS-B 214 generates the ACR message [initial] with the new media based charging information AVP as a part of IMS information AVP. In other embodiment the ACR message can also be sent by the S-CSCF if the AS is not involved in the call flow. The ACR message is sent (716) to the CDF B 212. In response to the ACR the CDF B 212 sends (717) the ACA message to AS-B 214. AS-B 212 then sends (718) the response message (received earlier from S-CSCF B 213) back to S-CSCF B 213. S-CSCF B 213 sends (719) the response message to S-CSCF A 206. The S-CSCF A 206 in turn sends (720) the response message to AS-B 214. If CCR message was not sent earlier on reception of the invitation message, then CCR [initial] would be sent to the OCS-A 205 now. The CCR message with the new updated body is sent (721) to the OCS-A 205. The CCA message is sent (722) in response to the CCR message received. Further AS-A 207 examines the response message and sends (723) the message to S-CSCF A 206. The response message is sent (724) to P-CSCF A 203, that sends (725) the message to the user A 101. The session continues after the user A 101 sends an acknowledgment message. The User B 102 now generates a re-invitation message with a new application body that may include modified charging based information content. The re-invitation message is sent (726) to P-CSCF 13 210. Re-invitation message with a new application body is sent (727) to S-CSCF B 213. The S-CSCF B 213 sends (728) the re-invitation message to AS-B 214, AS-B 214 sends (729) the re-invitation message to S-CSCF B 213. S-CSCF B 213 sends (730) the re-invitation message to S-CSCF A 206. The re-invitation message is sent (731) to AS-A 207. AS-A 207 sends (732) the CCR message to the OCS-A 205 since there is an update in the media content to be charged. The CCA message is sent (733) to AS-B 214. The re-invitation message is then sent to S-CSCF A 206. The S-CSCF A 206 examines the message and sends (734) the re-invitation message (735) to the P-CSCF A 203. Finally the re-invitation message is sent (736) to user A 101. User A 101 sends the response message in response to there-invitation message. The response message with the updated application body is sent (737) to P-CSCFA 203. The P-CSCF A 203 stores the charging related information and informs the charging functions, if applicable. The response message is sent (738) to S-CSCF A 206, S-CSCF A 206 sends (739) the response message to AS-A 207. AS-A 207 checks the user profile and informs the charging functions. The response message is then sent (740) to S-CSCF A 206. The response message is sent (741) to I-CSCF B 215. The I-CSCF B 215 sends (742) the response message to S-CSCF B 213. S-CSCF B 213 sends (743) the response message to AS-B 214. The AS-B 214 checks the profile and settings of user B 102 and generates ACR [interim] message with updated charging based information in the message. The ACR message is sent (744) to CDF-B 212 which maintains the charging data for User B. The CDF-B 212 sends (745) an ACA message back to AS-B 214. The AS-B 214 sends (746) the response message to S-CSCF B 213. All the messages sent are examined by S-CSCF B 213. S-CSCF B 213 sends (747) the response message to P-CSCF B 210. The P-CSCF 210 sends (748) the response message to user B 102.

As an embodiment, the basic charging indicator framework, as well as in the charging offer answer model will have interactions with other services and features. The handling of these functions is the decision of the network operator. Consider the case of forwarding the session or the session diversion. In case of basic charging indicator framework there can be different possible scenarios. One being, when the calling party (say user A) initiates a session, the terminating side network or the called party network (say of user B) will examine the profile of the called party and decide the called party has to bear the charges of the session. The information could also be indicated in the response of the originating side network. User A makes a call to the called party and if the called user B does not answer, the session is forwarded to another user (say user C) which is pre-defined by the user B in his profile settings. Now, the terminating network of the user C to whom the session is forwarded by user B, decides the session will be charged to user A. The case above can be handled in two ways. In the first solution, the application server of user A notices that the user B has diversion active in the user profile, and the diversion is activated for the present session. Hence, the Application server will not include charging related details in the invitation message sent to the user C to where the session is forwarded. In addition, the application server can decide to not send any answer to the offer made, or send an answer in the response message with the default settings indicating non-acceptance of the offer. Or sending an error response with the Reason header ‘supplementary service interaction not allowed’. If the charging offer is made by the other user C to whom the session is forwarded by means of the re-invitation message, the application server of user B will send one of the above discussed responses.

In another embodiment, the application server of original called user(i.e., user B) will update the charging functions, and send a charging answer indicating acceptance of the charging offer only when the user B′s profile indicates the offer can be accepted automatically or the cases wherein the checks performed by the application server of user B are successful. The diverting, network can also store the charging offer internally. The application server shall include the new charging offer in the invitation message only when the required information is present in the application server of the original called party (i.e., user B) and the application server is able to indicate in the invitation message that the session is diverted (for example, by including the Diversion header). In such cases the diverted to user's (User C) application server will trigger the charging functions appropriately on seeing the charging offer. The application server of User C will then send an appropriate charging answer in the 18×/200 OK response towards User B's network. User B's AS on receiving the charging answer, will update the charging functions accordingly, and it will send a charging answer to User A's network that is based on the charging offer it received in the INVITE message from User A.

In another embodiment, the called user can have SIP forking mechanism active. SIP forking is defined as mechanism wherein multiple answers can be established from a single request. In case of SIP forking the following scenarios can be possible. The originating network of the calling party sends the offer for charging in the invitation message to the called party. The terminating network in the response message sends different answers to the invitation message, as the SIP forking mechanism is active. Further depending on the network or the operator's choice the case can be handled in two ways. The ‘most favorable’ answer in the response can be given preference when accepting the response. The most favorable answer can be pre-defined by the called party in his profile settings. Or there is no change to the existing implementation, i.e., the session continues with the endpoint returning the first valid 200 OK response to the invitation message. Considering the second case where the called party network is sending different offers in the response message. The situation can be handled in two ways. Either the ‘most favorable’ offer received in the response message can be given preference. The most favorable offer can be pre-defined by the called party in his profile settings. The terminal sending the first 200 OK response may also be accepted, and the appropriate answer sent in the ACK as long as it is not violating any pre-defined settings in the originating user's profile. The originating user may also be consulted, and/or the offer can be forwarded to the calling user.

As another embodiment the system can handle multi party sessions. The session set up can involve two parties or even multi parties. In case of multi party session, possible that different parties can be charged for different portions of the call. For example, one party is charged for the audio part, the other parties bear the charges for the video part. Or the combination of different charging schemes is also possible. In the above manner it is possible to charge different parties for different portions of the session. The respective networks should ensure that the charging is done correctly for each portion of the session. However, the operational complexity and charging related information flow over the network can be higher for such sessions.

In another embodiment different extensions and enhancements are possible for the mechanism. The user can define his preferences during registration with the network. The user during registration can indicate whether he is willing to accept the reverse charged sessions. This would require an inclusion of the charge indicator info in the register message also. As an example, when the user is on roaming, he can indicate during registration that he does not accept reverse charging sessions. The S-CSCF or the application server will then handle the situation and trigger the update of the user profile accordingly in the HSS. In addition, the user can even indicate rejection for higher bandwidth calls. It is also possible to have consultative charging update scheme in which whenever there is an update in the charging related information or the application body of the message, performed by, the network, the user can be informed of the operations by a text message or an in-band local announcement can be given to the user to indicate his acceptance or rejection of the offer. Further, various restrictions can be introduced at the end user level. The user can indicate his preference for differential charging by updating his profile by entering a service code. The facility can be included as a service/feature which can be invoked, deactivated etc. The other aspect of restriction can be imposition of the limitations by the network on what the end user can modify or update regarding the charging related information. For example, the user may not be allowed to modify the charging indications in the application body of the message to ‘none’. A further enhancement can be provided by allowing only the privileged users to modify the charging information in the application body. As a part of the application body additional information can be passed over the network indicating which charging information is generated or either modified by the network and which charging information is modified by the user. In case of the network generated information or updates the charging indicator should comply with the rules applicable for the basic charging framework. In addition, the user agent can be involved to have default setting in the charging indicator. The default settings can be to initiate or respond to the charging indicator updates. For example, a default setting could be not to accept the party to be charged as ‘called’ for any calls and this default setting can be included in any SIP message.

In another embodiment the exceptional cases like the case wherein the charging offer is not acceptable by the user or the network generating the offer. The session can be terminated with a new reason header saying charging answer not acceptable. Also in cases where there is violation in the basic charging model, the session can be terminated by sending a cancel message or any other terminating message with the appropriate reason header.

The embodiments disclosed herein can be implemented through at least one software program running on at least one hardware device and performing network management functions to control the network elements. The network elements shown in FIG. 1 include blocks which can be at least one of a hardware device, a software module or a combination of hardware device and software module.

The embodiment disclosed herein specifies a method of conveying the dynamic charging related information for the communication sessions. The mechanism allows different parties involved in the session to be charged for different parts of the session. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the invention may be implemented on different hardware devices, e.g. using a plurality of CPUs.

What is claimed is a:

1. A method for determining charging information in a SIP/IMS network for an ongoing session, said method comprising of
participants (101/102) in said session indicating charging information for media present in said session; and
participants (101/102) in said session negotiating on charging information for said session.

2. The method, as claimed in claim 1, wherein said method further comprises of
network (103) of a first user (101) inserting said charging information in a message from said first user to a second user (102);
said network (103) informing a charged user of charge as indicated in said charging information; and
network (103) of said second user (102) removing (306) said charging information from said message; before forwarding said message to said second user (102).

3. The method, as claimed in claim 1, wherein said method further comprises of
charging information being inserted (302) in a message from a first user (101) to a second user (102), said charging information being inserted by one of
said first user (101); and
network (103) of said first user (101);
network (103) of said first user (101) sending (305) said charging information to network of said second user (102);
negotiations occurring between said first user (101), network (103) of said first user (101), second user (102) and network (103) of said second user (102); and
an acknowledgement being sent (808) to said first user (101) on completion of said negotiations; said acknowledgement being sent by one of
said second user (102); and
network (103) of said second user (102).

4. The method, as claimed in claim 1, wherein said charging information is a charging indicator.

5. The method, as claimed in claim 1, wherein said charging information can be inserted in one of
INVITE message;
RE-INVITE message;
UPDATE message;
18× response messages;
200 OK messages; and
ACK messages.

6. The method, as claimed in claim 1, wherein said participants comprises of
said first user (101);
network (103) of said first user (101);
said second user (102); and
network (103) of said second user (102).

7. The method, as claimed in claim 1, wherein sessions between said first user (101) and said second user (102) are charged according to media attributes of said sessions.

8. The method, as claimed in claim 7, wherein charging according to media attributes of said sessions are informed to said first user (101) and said second user (102).

9. The method, as claimed in claim 7, wherein said charging information is used to carry information of charging according to media attributes of said sessions to a billing module in said network.

10. The method, as claimed in claim 1, wherein user to be charged for said sessions may change during said sessions depending on events occurring during said session.

11. A system for determining charging information in a SIP/IMS network for an ongoing session, said system comprising of
an indication means for participants in said session to indicate charging information for media present in said session; and
a negotiation means for said participants to negotiate charging information for said session.

12. The system, as claimed in claim 11, wherein said system further comprises of
an insertion means for network (103) of a first user (101) to insert said charging information in a message from said first user (101) to a second user (102);
an information means for said network (103) to inform a charged user of charge as indicated in said charging information; and
a removal means for network (103) of said second user (102) to remove (306) said charging information from said message; before forwarding said message to said second user (102).

13. The system, as claimed in claim 11, wherein said system further comprises of
an insertion means for a charging information to be inserted in a message from a first user (101) to a second user (102), said charging information being inserted by one of
said first user (101); and
network (101) of said first user (101);
a sending means for network (103) of said first user (101) to send said charging information to network (103) of said second user (102);
a negotiation means for carrying out negotiations between said first user (101), network of said first user (101), second user (102) and network (103) of said second user (102); and
an acknowledgement means for sending an acknowledgement to said first user on completion of said negotiations; said acknowledgement being sent by one of
said second user (102); and
network (103) of said second user (102).

14. A device connected to a IMS/SIP network, said device comprising of
an indication means for user of said device to indicate charging information for a session between said user (101) and a second user (102);
a negotiation means for said user (101) to negotiate with said second user (102) or network (103) of said second user (102); and
an acknowledgement means for said device to acknowledge charging information received from device of said second user (102).

15. A network (103), said network (103) being an IMS/SIP network, said network (103) comprising of
an indication means for said network (103) to indicate charging information in a message in a session using said network (103);
a negotiation means for said network (103) to negotiate with a user or network (103) of said user; and
a removal means for said network (103) to remove said charging information from said message; before forwarding said message to a user.
